(19) United States
(12) Patent Application Publication
(10) Pub. No.: US 2004/0165330 A1
(43) Pub. Date: Aug. 26, 2004

(54) Power bus for powering electronic devices operating in retail environments

(76) Inventors: Robert I. Wolinsky, Fairfield, CT (US); Martin A. Amadio, Glen Rock, NJ (US); Peter G. Goldring, Allendale, NJ (US); Stanley Kirshenbaum, Great Neck, NY (US); Mikhail L. Marsky, New York, NY (US)

Correspondence Address: Gerald T. Welch, Esq., Patton Boggs, LLP, Suite 3000, 2001 Ross Avenue, Dallas, TX, 75201, US

(21) Appl. No.: 10/760,802

(22) Filed: Jan. 20, 2004

Related U.S. Application Data
(60) Provisional application No. 60/441,367, filed on Jan. 20, 2003.

(51) Int. Cl. H01H 73/00

(52) U.S. Cl. 361/115

(57) ABSTRACT

A system and method for supporting and providing electrical power to devices. One embodiment includes an elongated member coupled to the structure and configured to support a device and to supply electrical power to the device. A coupling member is operable to engage the elongated member or power bus and support the device. The coupling member is operable to be moved from a first position to a second position along the elongated member to reposition the device with respect to the structure. In one embodiment, the elongated member is configured to supply electrical power to the device substantially continuously during movement of the coupling member along the elongated member.

### RELATED APPLICATIONS

This application claims the benefit to U.S. Provisional Application Serial No. 60/441,367 filed Jan. 20, 2003, which is incorporated in its entirety herein by reference.

### BACKGROUND OF THE INVENTION

1. Technical Field of the Invention

The principles of the present invention are generally directed to a power bus for delivery of electrical power to electronic and electrical devices operating in a retail environment, and more particularly, but not by way of limitation, to a rail conduit capable of delivering electricity and supporting at least a portion of an electronic or electrical device at substantially any location thereon.

2. Description of Related Art

Retail facilities often utilize electronic or electrical devices (“devices”) in relation to products and/or structures for supporting products. Such electronic devices may include electronic displays, coupon dispensers, or other electronic device utilized to provide and/or receive information to and from customers. The electronic devices also may include lights (e.g., fluorescent lights), vacuums, coffee seed grinders, and other electrical products. In providing power to these devices, an outlet or other plug-in type socket is typically wired. These wired electrical sockets are limited in that they may not be aesthetically pleasing and do not provide for the devices to be repositioned to any extent from the electrical socket without the use of an extension cord, which is not aesthetically pleasing. Alternatively, the devices may use batteries, but repositioning of the battery-powered devices Alternatively, the devices may use batteries, but repositioning of the battery-powered devices generally requires inconvenient and/or extensive mechanical reconfiguration, which is also true with repositioning devices that are connected to the electrical sockets.

Another problem with locating devices in relation to products is the need for hardware to mount the devices to the structure. The hardware is in addition to the wired socket and costs extra money in terms of cost and labor for installation and/or repositioning. For example, major retail chain stores are currently configured with structures that are used to display products. A typical major retail chain store may have 3 million structures. It is not economical for the retail stores, large or small, to purchase new structures. In addition, it is not cost effective to have electricians retrofit existing structures to be wired as the structures would either have to be disassembled, wired, and reassembled or be configured with wires that are not aesthetically pleasing and can be seen by customers.

### SUMMARY OF THE INVENTION

To overcome the problems and limitations of having (i) non-aesthetically pleasing electrical power sockets, (ii) inconvenient and/or extensive mechanical reconfiguration to reposition a device on a structure, and (iii) costly purchasing or retrofitting of structures, for example, the principles of the present invention provide for a system and method for supporting and providing electrical power to devices. One embodiment includes an elongated member coupled to the structure and configured to support a device and to supply electrical power to the device. A coupling member is operable to engage the elongated member or power bus and support the device. The coupling member is operable to be moved from a first position to a second position along the elongated member to reposition the device with respect to the structure. In one embodiment, the elongated member is configured to supply electrical power to the device substantially continuously during movement of the coupling member along the elongated member.

### BRIEF DESCRIPTION OF THE DRAWINGS

The disclosed invention will be described with reference to the accompanying drawings, which show sample embodiments of the invention and which are incorporated in the specification hereof by reference, wherein:

FIGS. 1-11 illustrate an exemplary portion of a structure that is utilized to support shelves (not shown) for products to be displayed;

FIG. 1 is an illustration showing a perspective view of the exemplary upright posts configured to mount adaptors into cavities disposed at the top of the upright posts;

FIG. 2 is an illustration showing a perspective view of the adaptors coupled to the upright posts of FIG. 1;

FIG. 3 is an illustration showing a perspective view of an exemplary power bus coupled to the adaptors of FIG. 2;

FIG. 4 is an illustration showing a perspective view of the reverse side of the power bus of FIG. 3;

FIG. 5 is an illustration showing a perspective view of a trolley or coupling element that may be used to couple with the power bus of FIG. 3 to support and to provide power to a device;

FIG. 6 is an illustration showing a perspective view of an exemplary configuration of multiple opposing power buses on the upright posts and adaptors of FIGS. 1 and 2;

FIG. 7 is an illustration showing a perspective view of an exemplary configuration of the multiple opposing power buses of FIG. 6 with an end-panel to conceal the power buses for aesthetic and safety purposes;

FIG. 8 is an illustration showing a perspective view of two devices being powered by the power buses and extending from the trolley of FIG. 5;

FIG. 9 is an illustration showing a perspective view of exemplary upright posts with brackets coupled to slots disposed on the upright posts of FIG. 1;

FIG. 10 is an illustration showing an exemplary embodiment of a power bus being supported by the brackets of FIG. 9;

FIG. 11 is an illustration of the power bus of FIG. 10 including an end-panel to conceal the power bus for aesthetic and safety purposes;

FIGS. 12A and 12B are illustrations of front and inside views, respectively, of the exemplary power bus of FIG. 4;

FIGS. 13A-13D are illustrations showing a number of views of an exemplary bracket used for constructing a trolley;

FIGS. 14A-14D are illustrations showing a number of an exemplary slider component for use with the trolley of FIG. 13 that is used to slide or roll within conduits of the power bus of FIG. 4;

FIG. 15 is an illustration showing a side view of another exemplary embodiment of a trolley;

FIGS. 16A-16E are illustrations showing a number of views of the trolley of FIG. 15;

FIGS. 17A-17E are illustrations showing a number of views of an exemplary electrical connector for applying electricity to or receiving electricity from the power bus of FIG. 4;

FIGS. 18A-18G are illustrations of a number of views of an exemplary electrical connector utilized by the trolley of FIG. 16 for making an electrical connection to the power bus of FIG. 4; and

FIGS. 19A-19C are illustrations showing a number of views showing exemplary electrical conductors for use with the electrical connector of FIG. 18A.

### DETAILED DESCRIPTION OF THE DRAWINGS

The principles of the present invention generally relate to a power bus or elongated member that is capable of extending along a structure or fixture used to display products. The structure may be a gondola, shelf, or other retail fixture for displaying products. Alternatively, the power bus may be coupled to an architectural member of an edifice. The architectural member may be a wall, beam, pole, ceiling, floor, or other structural component that may or may not be configured to display products.

The power bus may support and provide electrical power for use by devices. In one embodiment, the devices may access power from the power bus at substantially any location thereon. Alternatively, the power bus may be configured to provide electrical power at certain locations rather than substantially the entire length. The power bus may be formed of one or more elongated members. In one embodiment, the elongated members are rails in the shape of a conduit, tube, or other geometric configuration. The elongated members may also include demarcations or predetermined separation and/or connection points to make shorter or extend the elongated members. Power may be delivered along one or more electrical conductors that are part of or coupled to the power bus (see, for example, FIGS. 19A-19C). In one embodiment, the electrical conductors may be copper strips that deliver power along the power bus. Alternatively, copper tape may be applied to the power bus and be utilized to conduct electricity to devices in contact therewith. Both a HIGH side and LOW or ground (GND) side power bus may be provided as understood in the art. In one embodiment, the HIGH side of the power bus delivers an alternating current (AC) signal (e.g., 40 VAC). Alternatively, the HIGH side of the power bus may deliver a direct current (DC) signal. The GND side of the power bus may be either a conductor or the elongated member itself.

In addition to the power bus being capable of conducting power, the power bus may further be utilized to conduct information signals to and from devices, where the information signals may include content (e.g., image, video, audio, data) and control information (e.g., brightness, reset, location, data). In one embodiment, information or data representative of a video image may be communicated along the power bus, either along one of the conductors (i.e., HIGH or GND) or on a separate conductor or data line. Control information further may be communicated via the power bus or data line so that devices may timely and properly display the video image, for example.

FIGS. 1-11 illustrate a portion of an exemplary structure 100 that is utilized to support shelves (not shown) for retail products to be displayed. As shown in FIG. 1, one embodiment of upright posts 102 may be utilized to mount adapters 104 into cavities 106 disposed at the top of the upright posts 102. Alternatively, the adapters 104 may be configured to be supported by the upright posts 102 by covering the top of the upright posts 102 and extending toward the floor about the upright posts 102, thereby operating as a sleeve. The adapters 104 may be used to support a power bus, such as that shown in FIGS. 3 and 4.

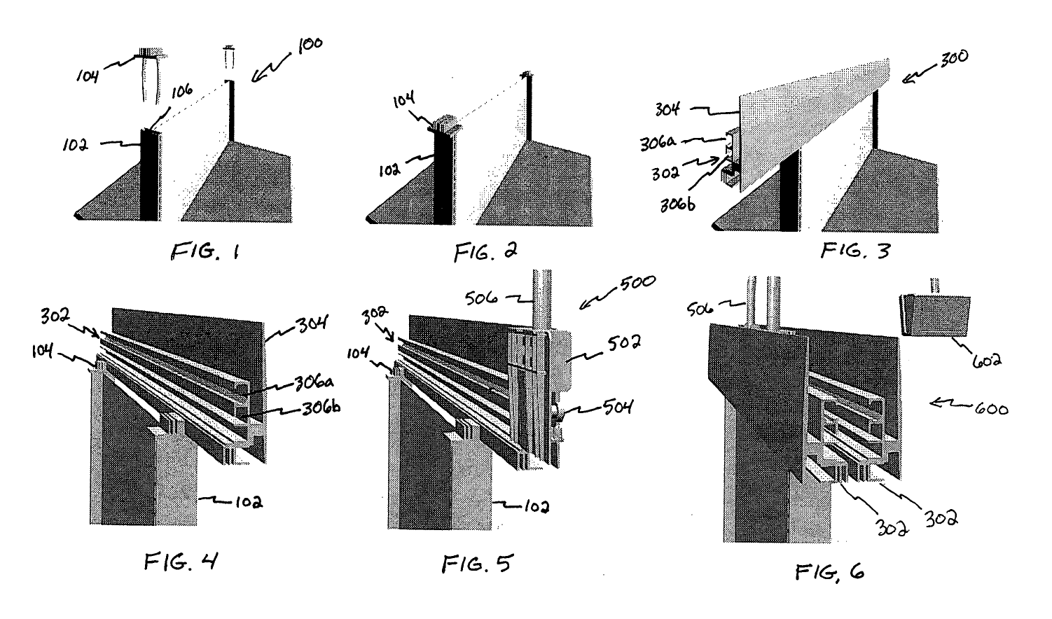

FIG. 2 shows the adapters 104 of FIG. 1 engaging the upright posts 102. The adapters 104 may be configured as a universal adapter such that it is capable of being mounted to multiple variations (i.e., different makes and models of the same or different manufacturers) of upright posts 102 or be customized to fit one particular upright post 102. Alternatively, the adapters 104 may be configured to be coupled to the side of a structure.

FIG. 3 shows a configuration 300 of an exemplary power bus 302 coupled to the adapters 104 of FIG. 1. In one embodiment, the power bus 302 may include or be coupled to a panel 304 for concealing the power bus 302 from view by customers at a retail location. By concealing the power bus 302 from customers, the fixturing is more aesthetically pleasing and prevents contact by people and objects with the power bus 302 while powered. In another embodiment, the panel 304 may include mounts for printed or electronic displays (e.g., LED or LCD display). The power bus 302 also may include multiple rails or conduits 306a and 306b (collectively 306) that are used to conduct power along the power bus 302. The conduits 306 may be conductive or have a conductive material (not shown) applied thereto. For example, a copper tape may be applied to each of the conduits 306 so that one carries HIGH voltage potential (e.g., 120 VAC) and the other is at a ground voltage potential as understood in the art. In another embodiment, one conduit 306a may include a separate conductor (e.g., copper tape) to supply a HIGH voltage signal and the GND signal may be the conduit structure itself. Still yet, multiple conductors may be utilized to supply multiple HIGH and LOW voltage signals to one or more devices in electrical contact with the power bus 302.

In addition, the same or separate conductors (e.g., conduits 306 or conductive material) may be utilized to carry signaling information (i.e., data and control information). The power bus 302 may further be capable of supporting at least a portion of an electronic device directly or by an extension arm (see FIG. 8). A device may be configured to adapt to the power bus 302 via a housing of the device. Alternatively, a coupling device (see, for example, FIG. 16) may be provided to support a device. In either case, both the housing of the device configured to engage the power bus 302 and the coupling device are considered to be coupling devices.

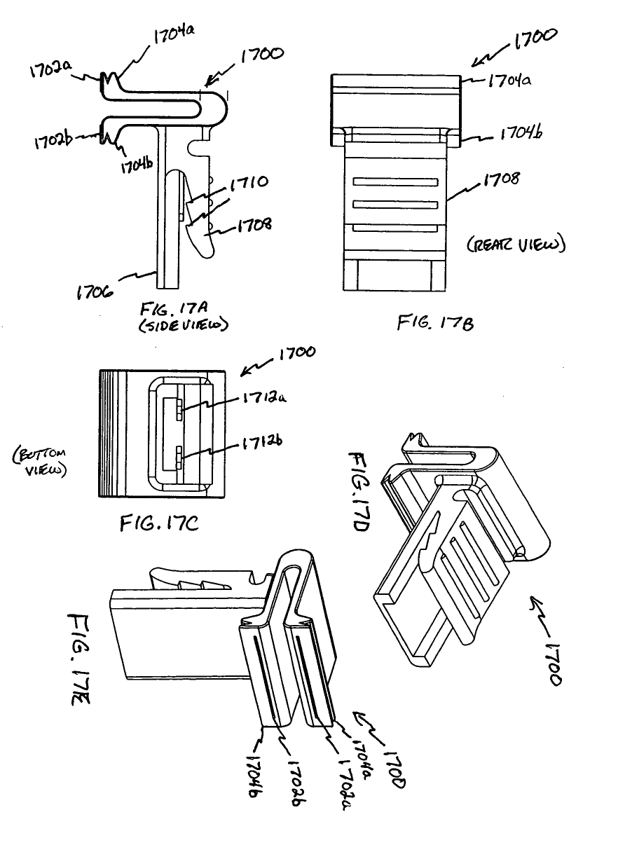

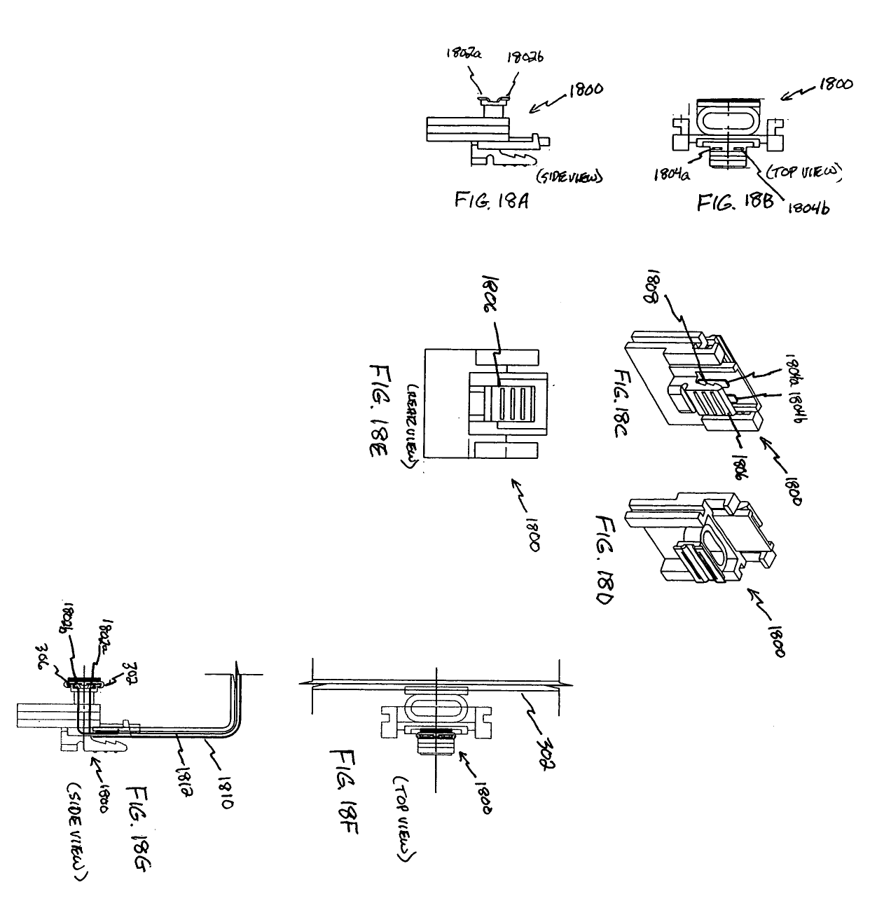

In addition to the power bus 302 supporting the device, repositioning of the device requires minimal or no mechanical reconfiguration. For example, the device may be moved via a trolley (see FIG. 5) coupled to the power bus 302. Alternatively, the device may be moved by rotating a knob (not shown) or altering position of a set screw (not shown) that may be utilized to secure the device to the power bus 302 as understood in the art. It should be understood that there may be multiple power buses 302 configured to a single structure to provide for multiple power access points and contact methods. For example, there may be a power bus 302 on the inside of a structure (i.e., an inside power bus) that enables a trolley (see FIG. 5) to engage the inside power bus 302 and a power bus 302 on the outside of the structure (i.e., an outside power bus) that enables an electrical connector (see FIG. 17) to engage the outside power bus 302.

FIG. 4 shows the reverse side of the power bus of FIG. 3. As shown, conduits 306 are configured to receive a slidable or rotatable member (not shown) to provide mobility of a device along the power bus 302. The power bus 302 engages and/or is coupled to the adapters 104 that are coupled to the upright posts 102. The panel 304, which may be coupled to the power bus 302, conceals the power bus 302 from being viewed by customers at a retail location, for example.

FIG. 5 is a configuration 500 of an exemplary coupling member, which in this case is a trolley 502, that may be used to couple with the power bus 302 to support an electronic device. The trolley 502 may include one or more rollers 504, knobs, or other protrusions, such as flat surfaces that operate as slides (see, for example, FIG. 19), that may be inserted within one or more of the conduits 306. The rollers 504 may be conductive so as to receive power from the power bus 302. Alternatively, another conductive mechanism, such as spring loaded contacts or electrodes, that extends from the trolley 502 may be utilized to receive power from the power bus 302. In one embodiment, a metallic element (not shown) extending from the trolley 502 may be contacted with conductive surfaces of the power bus 302. The conductive mechanism may or may not be spring loaded. Alternatively, another mechanism to maintain contact with the conductive surfaces may be utilized as understood in the art.

Because the rollers 504 of the trolley 502 may be inserted into the conduits 306, the trolley 502 may be disposed at substantially any position along the power bus 302. The device may be repositioned by sliding or rolling the trolley 502 along the power bus 302. During the repositioning, conductive mechanism(s) may maintain contact with the power bus 302 so that the device being powered maintains power and signaling substantially continuously during the repositioning process. By using a power bus 302 as provided, no or minimal reconfiguration to a structure (e.g., gondola) is needed to reposition the device.

As the trolley 502 is moved, gaps that may be intentionally positioned in the conductors may cause a disruption of power to the device so that the device automatically resets, updates, or requests an update of its position from a user, thereby ensuring that the device does not maintain or obtain incorrect information (e.g., product advertising) that is related to a previous position of the device. Various methods for providing a reposition signal to the device before, during, or after being repositioned may be utilized. One embodiment for providing a reposition signal to the device includes sensing a change in position via a sensor (not shown). The sensor may be mechanical, optical, magnetic, electrical, electronic, and the like as understood in the art. Another method is to sense motion (e.g., engagement or disengagement) of a lock or connector of the trolley or device to the power bus. In response to there being a repositioning, either automatically determined by a sensor or a manual entry being entered into the device, a repositioning signal may be communicated to a system (e.g., computer) via a wired or wireless connection for informational or other purposes.

An extension arm 506 may be coupled to the trolley 502. In one embodiment, the extension arm 506 may extend vertically from the trolley 502. Alternatively, the extension arm 506 may extend in any other direction from the trolley 502 and/or include one or more hinges to enable a user to position the device coupled to the extension arm 506 in any position and/or orientation. The extension arm 506 may be tubular or other geometric shape. In one embodiment, the extension arm 506 is hollow to enable conductors, such as wires, to extend therethrough to supply power to the device from the power bus 302. Alternatively, conductive surfaces may extend along the surface of the extension arm 506 to supply power to the device.

FIG. 6 is an exemplary configuration 600 of multiple opposing power buses 302 configured to the upright posts 102. An exemplary device 602 may be supported by the extender arm 506. In this case, the device 602 is an electronic display screen that may display content to customers at a retail store, for example. As shown, the multiple opposing power buses 302 are configured such that each may pass one another when engaged on the opposing power buses 302 (see, for example, FIG. 15). Also shown are panels 504 that are configured to conceal the power buses 302.

Other types of devices that are being utilized in retail environments include wireless devices. More specifically, RFID devices are used to track items located in the retail environment and/or on specific shelf locations. By configuring the RFID devices on the power bus 302, the RFID devices may be repositioned with minimal or no structural modification of the structure to which the power bus is mounted. Additional information regarding RFID devices is described in co-pending U.S. patent application 60/487,650 filed on Jul. 16, 2003, which is herein incorporated by reference in its entirety. Other wireless devices, such as optical devices, may be powered by the power bus 302.

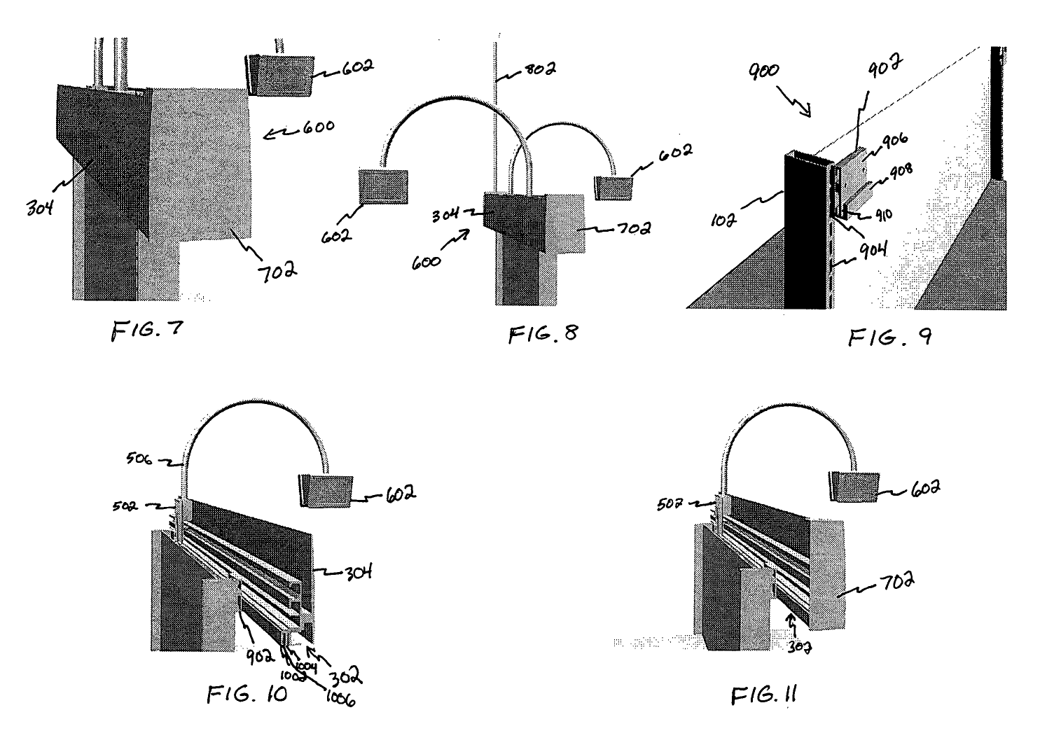

FIG. 7 is an illustration showing a perspective view of an exemplary configuration of the multiple opposing buses 302 of FIG. 6 with an exemplary end-panel 702 to conceal the power buses 702 for both aesthetic and safety purposes. Because the end-panel 702 may adapt to the power buses 302, the end-panel may itself be a device (e.g., display) that may be utilized to display information to customers. For example, aisle number and/or aisle content may be displayed. Although the end-panel 702 shown is configured to be approximately the same size as the area defined by the opposing power buses 302, it should be understood that larger sized or different shaped end-panels 702 maybe utilized.

FIG. 8 is an illustration showing a perspective view of two devices 602 being powered by the power buses 302 and extended from the trolley (not shown) of FIG. 5. The devices 602 may be repositioned along the power bus concealed behind the panels 304 and 702 by moving the trolley along the power bus. It should be understood that multiple devices may be supported and supplied power by the power bus via the trolley. Other mechanisms, such as a clip (see, for example, FIG. 17), may be utilized to engage the power bus 302 and supply power to the devices.

Further shown in FIG. 8 is a power cable 802 extending from a ceiling (not shown) to supply power to the power bus. Alternatively, other power cables from other locations, such as the floor, structure, other power buses, etc. In general, for safety purposes and conforming to device supply power specifications, a transformer may be utilized to lower or convert electrical power being supplied to the power bus. In one embodiment, rather than having a transformer packaged in a “box”, a transformer (not shown) may be formed in a housing of a trolley. The transformer may be locked to the power bus to avoid injury due to high power being applied to the transformer and to ensure proper contact with the power bus.

FIG. 9 is an illustration showing a perspective view of an exemplary structure 900 including upright posts 102 with brackets 902 to slots 904 disposed on the upright posts 102 of FIG. 1. The brackets 902 may be utilized to support the power bus 302 as shown in FIG. 10. The bracket 902 may be composed of metal, metal alloy, or plastic material that is capable of supporting the power bus (not shown). In addition, while the brackets 902 are coupled to the slots 904, other supporting and/or bracing mechanisms may be utilized to add strength to support the power bus. The bracket 902 includes a base plate member 906 and a lip member 908 extending from the base plate member 906, thereby forming a slot 910 by which the power bus 302 may be supported. Additional and/or other fastening mechanisms, such as additional slots, screws, fastening mechanisms, or other devices for securing the power bus to the bracket may be utilized.

FIG. 10 is an illustration showing an exemplary embodiment of the power bus 302 being supported by the brackets 902 of FIG. 9. As shown, the power bus 302 includes members 1002 and 1004, which are substantially parallel and extend vertically downward, thereby forming a slot 1006. The lip 908 (FIG. 9) may thereby extend into the slot 1006 and the member 1002 may extend into the slot 910 so that the bracket 902 supports the power bus 302. The trolley 502 (FIG. 5) is shown to be engaged with the power bus 302 to support and supply power to the device 602.

FIG. 11 is an illustration of the power bus 302 of FIG. 10 including an end-panel 702 (FIG. 7) to conceal the power bus for aesthetic and safety purposes. The end-panel 702 maybe locked into position by a locking mechanism (not shown) such that there is a prevention of the trolley 502 from being positioned off of the power bus 302, which, in addition, acts to prevent theft of the device 602.

It should be understood that the two configurations (i.e., coupling power bus to the upright posts via adapters on the top of the upright posts 102 or coupled to slots of the upright posts 102) provided herein are merely exemplary and that many other configurations are possible in accordance with the principles of the present invention. For example, the power bus 302 may be mounted to a wall, mounted to a ceiling, mounted below a shelf, or extended from the edge of a shelf. Further, the length of the power bus 302 may be varied according to the particular application that the power bus is to be applied. In one embodiment, the power bus 302 may have “break points” (not shown) where it may be separated or severed to form different lengths. Alternatively, and/or additionally, “connection points” (not shown) may be included on the power buses to enable lengthening or extending a power bus. In lengthening the power bus, a conductive jumper may be configured between individual power buses so that electrical power is continuous across the entire length of power buses and that only one power supply is needed to power an entire extended power bus. The power bus 302 may also be configured in a variety of different orientations, such as vertically or diagonally. The trolley 502 may have a set screw or other fastening mechanism to lock the trolley 502 in place on the power bus 302 if the power bus 302 is oriented other than horizontally.

FIG. 12 is an illustration of front and inside views of the exemplary power bus 302 of FIG. 4. As shown, conduits 1202 and 1204 extend along the power bus 302 and members 1206 and 1208, which are utilized to secure a coupling device (e.g., trolley 502) and to enable the coupling device to be moved or repositioned thereon. FIG. 12B illustrates a side view of the power bus 302. As shown, the conduits 1202 and 1204 extend along the power bus 302.

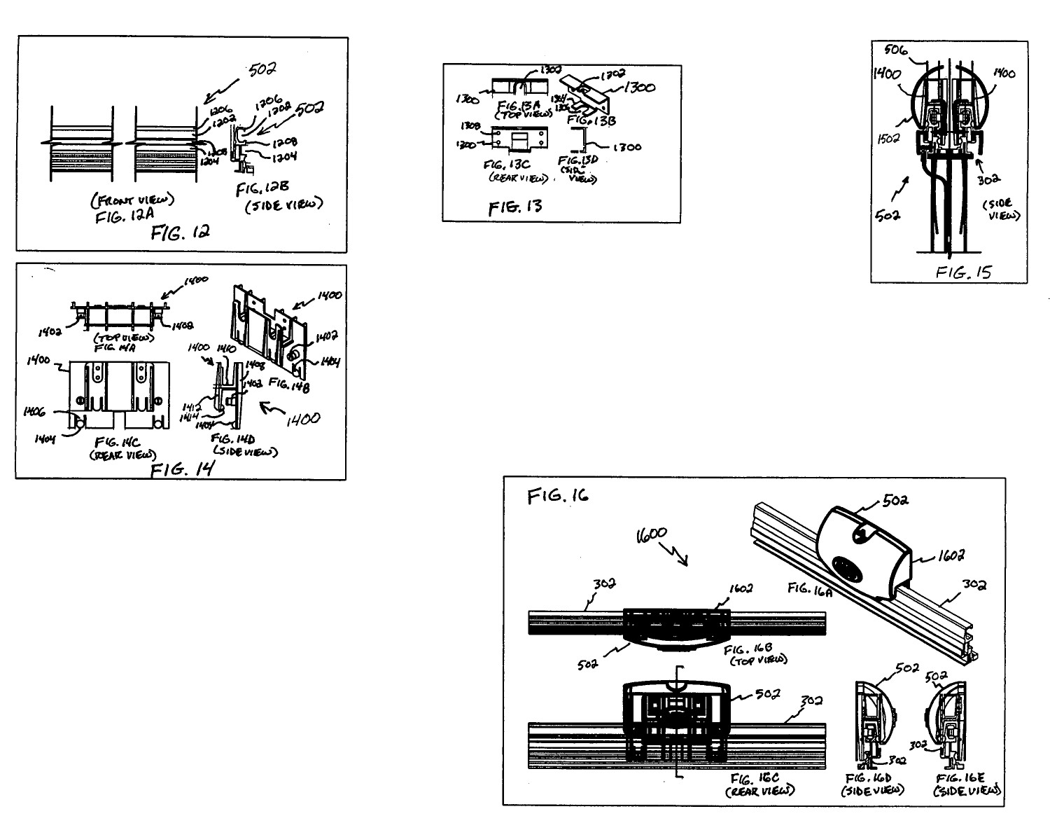

FIG. 13A illustrates a top view of an exemplary bracket 1300 used for constructing a trolley. The bracket 1300 includes a U-shaped indentation 1302 to enable an extender arm (see, for example, extender arm 506 of FIG. 10) to be supported by the bracket 1300. FIG. 13B illustrates a perspective view of the bracket 1300 showing that a member 1304 includes a U-shaped indentation 1306 that is aligned with the U-shaped indentation 1302 for aligning and supporting the extender arm. FIG. 13C is a rear view of the bracket 1300. Connector openings 1308 may be utilized to secure another bracket member (not shown) for maintaining position of the extender arm. FIG. 13D is a side view of the bracket 1300.

FIG. 14A is an illustration showing a top view of an exemplary slider component performing a trolley that is used to slide or roll within the conduits of the power bus 302 of FIG. 4. As shown, a first protrusion 1402 extends from slider component 1400 to extend through a conduit of the power bus 302. In one embodiment, the first protrusion 1402 may be conductive to operate as an electrode for accessing power from the power bus 302. Still yet, the protrusion 1402 may be rotatable such that it operates as a wheel to enable the trolley to roll along the power bus 302. The first protrusion 1402 may also be spring loaded to maintain position and contact with a conductive surface. FIG. 14B is an illustration showing a perspective view of the slider component 1400 that includes the first protrusion 1402 and a second protrusion 1404. The second protrusion 1404 may extend into a conduit of the power bus 302 to support the trolley. Additionally, the second protrusion 1404 may be conductive such that is receives a voltage potential (e.g., ground) for supplying to a device. FIG. 14C is a rear view of the slider component 1400. As shown, the second protrusions 1404 are disposed on flap members 1406, which may provide a “spring” operation to enable the second protrusion 1404 to maintain contact with a conductive surface of the power bus 302. FIG. 14D is an illustration of a side view of the slider component 1400. As shown, the slider component includes a first vertical member 1408 that the first protrusion 1402 and second protrusion 1404 are coupled. An extender member 1410 extends from the first vertical member 1408 to maintain position of a second vertical member 1412. A third protrusion 1414 may be coupled to a surface that opposes the first vertical member 1408. The third protrusion 1414 may extend into a conduit of the power bus for alignment and/or other purposes, such as supplying power or signals to a device.

FIG. 15 is an illustration showing a side view of another embodiment of the exemplary trolley 502 of FIG. 5. As shown, the slider element 1400 is configured to adapt to the power bus 302. As shown, extender arms 506 are configured to be supported by the trolley 502. The trolley 502 may have a curved side surface 1502 for aesthetic and safety purposes.

FIG. 16A is an illustration showing a perspective view of the trolley 502 of FIG. 15. As shown, the trolley 502 is engaged (i.e., in working operation) with the power bus 302 of FIG. 4. Accordingly, the trolley 502 may be utilized to support a device on the power bus 302 and supply electrical power and signaling from the power bus 302 to the device. The trolley 502 may have two or more conductive contacts (not shown) and a separate signal contact (not shown) if the power and signaling buses are separate. As shown, the trolley 502 may have a flat, low profile rear surface 1602 to enable back-to-back trolleys 502 to pass each other without contact or interference. FIG. 16B is an illustration showing atop view of the trolley 502 engaging the power bus 302. As shown, the flat surface 1602 is low profile such that two power buses 302 may be disposed in relation to enable two trolleys 502 to pass one another during relocation of a device. FIG. 16C is an illustration showing a rear view of the trolley 502 engaging the power bus 302. FIGS. 16D and 16E are illustrations showing side views of the trolley 502 engaging the power bus 302.

FIGS. 17A-17E depict an exemplary electrical connector 1700 for applying electricity to or receiving electricity from the power bus 302 of FIG. 3. FIG. 17A is a side view of the electrical connector 1700 and shows two electrical conductor pads 1702a and 1702b (collectively 1702) extending from conduit guides 1704a-1704b (collectively 1704). The electrical conductor pads 1702 are placed in contact with conductors of the power bus 302 (see FIG. 19C) and are able to slide along the conductors and remain in contact therewith so as to provide substantially continuous power to the device being powered. A cable guide 1706 extends from the electrical connector 1700 to allow a power cable (see FIG. 19B) to be coupled with the electrical connector 1700. A connector clip 1708 may include teeth 1710 to assist in maintaining connection of the power cable.

FIG. 17B is a rear view of the electrical connector 1700. Conduit guides 1704, connector clip 1708, and power cable are shown. FIG. 17C is a bottom view of the electrical connector 1700. Two electrical contacts 1712a and 1712b (collectively 1712) are shown. The electrical contacts 1712 are utilized to engage electrical conductors of the power cable to conduct electricity between the power cable and the electrical conductor pads 1702. FIGS. 17D and 17E are perspective views of the electrical connector 1700. FIG. 17E shows the electrical contact pads 1702 extending from the bottom or end of the conduit guides 1704.

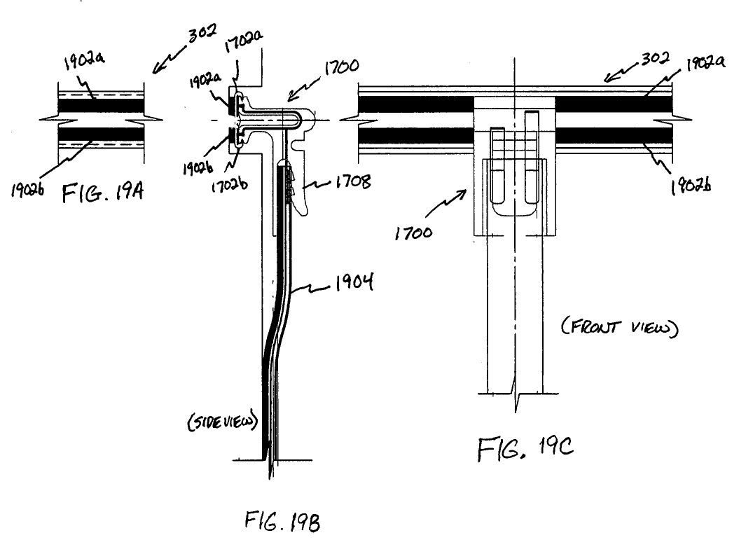

FIGS. 18A-18G are a number of illustrations showing a trolley electrical connector 1800 (i.e., an electrical connector utilized by the trolley 502 for mating an electrical connector to a power bus). As shown on FIG. 18A, there are electrical contact pads 1802a and 1802b (collectively 1802) that are utilized to contact the power bus (e.g., power bus 302 of FIG. 3). FIG. 18B is an illustration showing a top view of the trolley electrical connector 1800 having electrical contacts 1804a and 1804b disposed therein to engage conductors of a power cable. FIG. 18C is an illustration showing a perspective rear view of the trolley electrical connector 1800 showing the electrical contacts 1804a and 1804b disposed thereon for contacting the conductors of the power cable. The trolley electrical connector 1800 includes a connector clip 1806 having teeth 1808 for use in maintaining position of a power cable. FIG. 18D is an illustration that shows a front isometric view of the trolley electrical connector 1800. FIG. 18E is an illustration that shows a rear view of the trolley electrical connectors.

FIGS. 18F and 18G are exemplary configurations of the trolley electrical connectors 1800 in connection with the power bus 302. FIG. 18F is an illustration of a top view of the configuration showing the trolley electrical connector 1800 engaging the power bus 302. As shown in FIG. 18G, which is a side view of the configuration, the electrical connector 1800 engages the power bus 302 via the conduits 306 with the electrical contact pads 1802. A power cable 1810, which may be flexible or semi-rigid, having conductors 1812 may be coupled to the electrical connector 1800 via the electrical contacts 1804.

FIGS. 19A-19C are illustrations showing a number of views showing exemplary electrical conductors for use with the electrical connector of FIG. 18A. FIG. 19A illustrates an exemplary segment of the power bus 302 (FIG. 3) that includes a HIGH electrical conductor 1902a and LOW or GND electrical conductor 1902b (collectively 1902). The HIGH electrical conductor 1902a may supply or carry AC (e.g., 40 VAC) or DC (e.g., 12 VDC) for devices to be powered. Although shown as two electrical conductors 1902, there may be additional electrical conductors if other power levels (e.g., AC, DC, GND-AC, GND-DC) are desired for multiple devices that require different voltage supply levels and/or types.

FIG. 19B is an illustration of a side view of the power bus 302 with the connector 1700 (FIG. 17) engaged thereto. As shown, electrical conductor pads 1702a and 1702b contact the electrical conductors 1902 to supply power to a power cable 1904, which is secured via the clip 1708. The power cable 1904 may be used to deliver electrical power to a shelf edge, socket, device, or other electrical component. In an alternative embodiment, the electrical connector 1700 and power cable 1904 may be used to deliver electrical power to the power bus 302. Still yet, the power cable 1904 and electrical connector 1700 may be utilized to communicate data (e.g., video data) to and from the power bus 302.

FIG. 19C is an illustration of a front view of the electrical connector 1700 engaging the electrical conductors 1902 of the power bus 302. The electrical connector 1700 provides for sliding of the electrical connection point with the power bus 302 and for substantially maintaining power connection during the sliding operation. The configuration makes for an inexpensive and substantially hardware-free solution to moving power locations on structures to connect devices, for example.

The innovative concepts described in the present application can be modified and varied over a wide rage of applications. Accordingly, the scope of patented subject matter should not be limited to any of the specific exemplary teachings discussed, but is instead defined by the following claims.

We claim:

1. A system for providing electrical power to a device at a structure for displaying products, said system comprising:
an elongated member coupled to the structure and configured to support the device and to supply electrical power to the device; and
a coupling member operable to engage said elongated member and support the device, said coupling member operable to be moved from a first position to a second position along said elongated member to reposition the device with respect to the structure.

2. The system according to claim 1, wherein said elongated member is configured as a rail conduit for said coupling member to translate along.

3. The system according to claim 1, further comprising at least one electrical conductor extending along said elongated member for providing power for the device at multiple locations along the elongated member.

4. The system according to claim 3, wherein said coupling member includes at least one electrode, the at least one electrode being in electrical communication with the device and for contacting the at least one electrical conductor to deliver electrical power to the device.

5. The system according to claim 1, wherein the device is a display screen.

6. The system according to claim 1, wherein said coupling element is a trolley configured to translate along said elongated member.

7. The system according to claim 6, wherein the trolley includes at least one revolving member that contacts said elongated member.

8. The system according to claim 1, further comprising an extender arm coupling said coupling member and the device, said extender arm operable to position the device from the structure.

9. The system according to claim 1, wherein said elongated member is configured to supply electrical power to the device substantially continuously during movement of said coupling member along said elongated member.

10. The system according to claim 1, further comprising at least one data conductor coupled to said elongated member for communicating information signals to and from the device.

11. The system according to claim 10, wherein said at least one data conductor is at least one electrical conductor operable to supply the electrical power to the device.

12. A method for providing electrical power to a device at a structure for displaying products, said method comprising:
coupling an elongated member to the structure, the elongated member operable to support a device and to supply electrical power to the device;
engaging a coupling member to the elongated member, the coupling member operable to support the device; and
moving the coupling member from a first position to a second position along the elongated member to reposition the device with respect to the structure.

13. The method according to claim 12, wherein said moving the coupling member along the elongated member substantially continuously maintains electrical power to the device.

14. The method according to claim 12, wherein said moving includes rolling the coupling member along the elongated member.

15. The method according to claim 12, wherein said moving includes sliding the coupling member along the elongated member.

16. The method according to claim 12, further comprising extending the device from the coupling member.

17. The method according to claim 12, further comprising communicating information signals along the elongated member to and from the device.

18. A system for providing electrical power to a device at a structure for displaying products, said system comprising:
means for (i) supporting a device and (ii) supplying electrical power to the device, said means for supporting and supplying coupled to the structure;
means for coupling said means to the structure; and
means for coupling the device to said means for supporting and supplying, said means for coupling operable to be moved from a first position to a second position along said means for supporting and supplying to reposition the device with respect to the structure.

19. The system according to claim 18, further comprising means for conducting electrical power along said means for supporting and supplying.

20. The system according to claim 18, wherein said means for coupling the device to said means for supporting and supplying further including means for delivering electrical power to the device.

21. The system according to claim 18, wherein said means for coupling the device to said means for supporting and supplying further includes means for moving said means for coupling from the first position to the second position.

22. The system according to claim 18, further comprising means for extending the device from said means for coupling.

23. The system according to claim 18, further comprising means for supplying electrical power to the device via said coupling member substantially continuously during movement of said coupling member along said elongated member.

24. The system according to claim 18, further comprising means for communicating information signals to and from the device.

25. A system for providing electrical power to an electronic device at a structure, said system comprising:
an elongated member coupled to the structure and configured to support the electronic device and to supply electrical power to the electronic device; and
a coupling member operable to engage said elongated member and support the electronic device, said coupling member operable to be moved from a first position to a second position along said elongated member to reposition the electronic device with respect to the structure.

26. The system according to claim 25, wherein the structure is configured to display products.

27. The system according to claim 26, wherein the structure is an architectural member of a retail facility.

28. The system according to claim 25, further comprising at least one electrical conductor extending along the elongated member.

29. The system according to claim 28, wherein said at least one electrical conductor is configured to have electrical power accessed therefrom along substantially the entire length of said at least one electrical conductor.

30. A system for providing electrical power to a device, said system comprising:
an elongated member configured to support a wireless device and to supply electrical power to the wireless device; and
a coupling member operable to engage said elongated member and support the wireless device, said coupling member operable to be moved from a first position to a second position along said elongated member to reposition the wireless device with respect to the elongated member.

31. The system according to claim 30, wherein the wireless device is an electronic wireless device.

32. The system according to claim 31, wherein the electronic wireless device is an RFID electronic wireless device.

33. The system according to claim 30, wherein said elongated member is coupled to a structure for displaying products.
